(19) United States
(12) Patent Application Publication
(10) Pub. No.: US 2013/0037764 A1
(43) Pub. Date: Feb. 14, 2013

(54) MANIPULATION TOOL FOR BELLOWS

(71) Applicant: Tazio Stephan Grivetti, Chillicothe, IL (US)

(72) Inventor: Tazio Stephan Grivetti, Chillicothe, IL (US)

(73) Assignee: Caterpillar Inc., Peoria, IL (US)

(21) Appl. No.: 13/205,890

(22) Filed: Aug. 9, 2011

(51) Int. Cl. B66F 19/00

(52) U.S. Cl. 254/100

(57) ABSTRACT

A manipulation tool for a bellows includes a first arm and a first engaging member extending from the first arm. The first engaging member is configured to be removably engaged with an outer axial surface of a first flange portion of the bellows. The manipulation tool for the bellows further includes a second arm movably positioned with respect to the first arm along a longitudinal axis of the bellows, and a second engaging member extending from the second arm. The second engaging member is configured to be removably engaged with an outer axial surface of a second flange portion of the bellows.

### TECHNICAL FIELD

The present disclosure relates to bellows used with machines, and more particularly to a tool for assisting in manipulation of a bellows.

### BACKGROUND

Flexible tube elements, such as bellows, are used in a variety of applications, such as torque coupling and flexible joints in machine exhaust systems, to define a passage for liquid or gases, while accommodating movement and vibration. Conventionally, bellows include a convoluted body portion having a first flange portion and a second flange portion. The bellows is axially expandable and contractible and are installed between two pipes, generally within confined spaces. Various tools may be employed to manipulate the bellows.

For example, U.S. Pat. No. 5,407,237 (the '237 patent) discloses a flexible coupling for two pipes that have at least some degree of freedom with respect to one another. The '237 patent discloses a bellows tube having transversely corrugated flexible sidewalls, which terminate at each of two ends in a rounded hollow nozzle, each of which nozzles are sized to engage and connect said two pipes. The '237 patent also discloses a sealing means to seal each nozzle to each respective pipe such that the bellows tube flexes when there is a relative axial and/or lateral displacement between said pipes. Further, a means for axially compressing said bellows tube is provided to enable its removal and installation between said two spaced-apart pipes.

### SUMMARY

In one aspect, the present disclosure provides a manipulation tool for a bellows. The manipulation tool includes a first arm and a first engaging member extending from the first arm. The first engaging member is configured to be removably engaged with an outer axial surface of a first flange portion of the bellows. The manipulation tool for the bellows further includes a second arm movably positioned with respect to the first arm along a longitudinal axis of the bellows, and a second engaging member extending from the second arm. The second engaging member is configured to be removably engaged with an outer axial surface of a second flange portion of the bellows.

Other features and aspects of the present disclosure will be apparent from the following description and the accompanying drawings.

### BRIEF DESCRIPTION OF THE DRAWINGS

FIG. 1 is an isometric view of a manipulation tool engaged with a bellows, according to an aspect of this disclosure;

FIG. 2 is an exploded view of the manipulation tool of FIG. 1;

FIG. 3 is another isometric view of the manipulation tool of FIG. 1; and

FIG. 4 is a flow chart for a method of manipulating a bellows.

### DETAILED DESCRIPTION

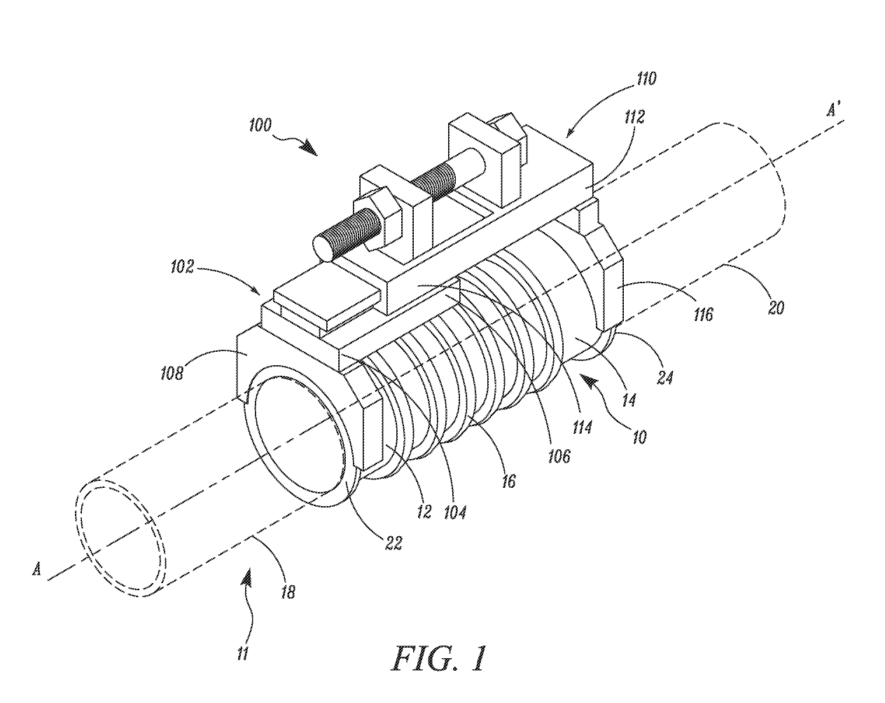

FIG. 1 illustrates an isometric view of a manipulation tool 100 with a bellows 10, according to an aspect of the present disclosure. In one embodiment, the bellows 10 may be installed within an exhaust system 11 of an engine (not shown). In such an embodiment, the engine may be any type of engine (internal combustion, gasoline, diesel, gaseous fuel, natural gas, propane, and the like), may be of any size, with any number of cylinders, may have any type of combustion chamber (cylindrical, rotary, spark ignition, compression ignition, 4-stroke, 2 stroke, etc.), and may be arranged in any configuration (in-line arrangement, “V” arrangement, radial arrangement, or the like). The engine may be used to power any machine or other device, including on-highway trucks or vehicles, off-highway trucks or machines, earth moving equipment, generators, aerospace applications, locomotive applications, marine applications, pumps, stationary equipment, or other engine powered applications.

The bellows 10 may provide a passage for flow of liquid or gases from the engine. The bellows 10 includes a first flange portion 12, a second flange portion 14 and a convoluted body portion 16 connecting the first flange portion 12 and the second flange portion 14. When the bellows 10 is installed in the exhaust system 11, the first flange portion 12 is connected to a first exhaust pipe 18 receiving exhaust gases, e.g., from the internal combustion engine, whereas the second flange portion 14 is connected to a second exhaust pipe 20. The convoluted body portion 16 of the bellows 10 is configured to be compressed and expanded due to the application of forces thereto. Exemplary embodiments include configurations wherein the bellows 10 may be composed of rubber, plastic, metal or a combination thereof. Further, while the present exemplary embodiment is described mainly with respect to the exhaust system 11 of an engine, various alternative embodiments may be used in various areas based on application and design requirements.

In an embodiment of the present disclosure, the manipulation tool 100 includes a first arm 102 having a first end portion 104, and a second end portion 106 disposed opposite to the first end portion 104. A first engaging member 108 may extend from the first end portion 104 of the first arm 102. In one exemplary embodiment, the first engaging member 108 may be integral with the first arm 102, that is, they may form a single, unitary, and indivisible component. Alternative exemplary embodiments include configurations wherein the first engaging member 108 may be connected to the first arm 102 by any conventional joining means, such as welding, brazing, rivets, or the like. The first engaging member 108 is configured to be removably engaged with the first flange portion 12 of the bellows 10. A portion of the first engaging member 108 is connected to the first end portion 104 of the first arm 102. In an embodiment, the first engaging member 108 may have a semi-circular shape. The semi-circular shape of the first engaging member 108 enables the first engaging member 108 to engage with an outer axial surface 22 of the first flange portion 12. In other exemplary embodiments, the first engaging member 108 may have various shapes to correspond with the different shapes of the first flange portion 12 of the bellows 10, for example, but not limited to, rectangular, square or triangular.

The manipulation tool 100 further includes a second arm 110 having a first end portion 112, and a second end portion 114 disposed opposite to the first end portion 112. The second arm 110 is movably positioned with respect to the first arm 102 along a longitudinal axis A-A′ of the bellows 10. In an embodiment, the first arm 102 and the second arm 110 may include a gear mechanism to move the second arm 110 with respect to the first arm 102. The gear mechanism may include, but not limited to, a rack and pinion arrangement, wherein the rack may be mounted on the first arm 102 and the pinion may be mounted on the second arm 110 or vice-versa. Upon engagement, a rotary motion of the pinion may be translated to a linear motion of the rake mounted on the first arm 102 with respect to the second arm 110. Moreover, a ratcheting mechanism, including a biased pawl, may be associated with the pinion or the rake of the gear mechanism to allow the movement of the first arm 102 with respect to the second arm 110 in a direction along the longitudinal axis A-A′. The ratcheting mechanism may also lock the first arm 102 with respect to the second arm 110 at a given position. In other embodiments of the present disclosure, an auxiliary mechanism, such as a hydraulic or a pneumatic mechanism may be associated with the first arm 102 and/or the second arm 110 to enable and control the relative movement.

A second engaging member 116 may extend from the first end portion 112 of the second arm 110. In one exemplary embodiment, the second engaging member 116 may be integral with the second arm 110, that is, they may form a single, unitary, and indivisible component. Alternative exemplary embodiments include configurations wherein the second engaging member 116 may be connected to the second arm 110 by any conventional joining means, such as welding, brazing, rivet, or the like. The second engaging member 116 is configured to be removably engaged with the second flange portion 14 of the bellows 10. A portion of the second engaging member 116 connected to the first end portion 112 of the second arm 110. In an embodiment, the second engaging member 116 may have a semi-circular shape. The semi-circular shape of the second engaging member 116 enables the second engaging member 116 to engage with an outer axial surface 24 of the second flange portion 14. In other exemplary embodiments, the second engaging member 116 may have various shapes to correspond with the different shapes of the second flange portion 14 of the bellows 10, for example, but not limited to, rectangular, square or triangular.

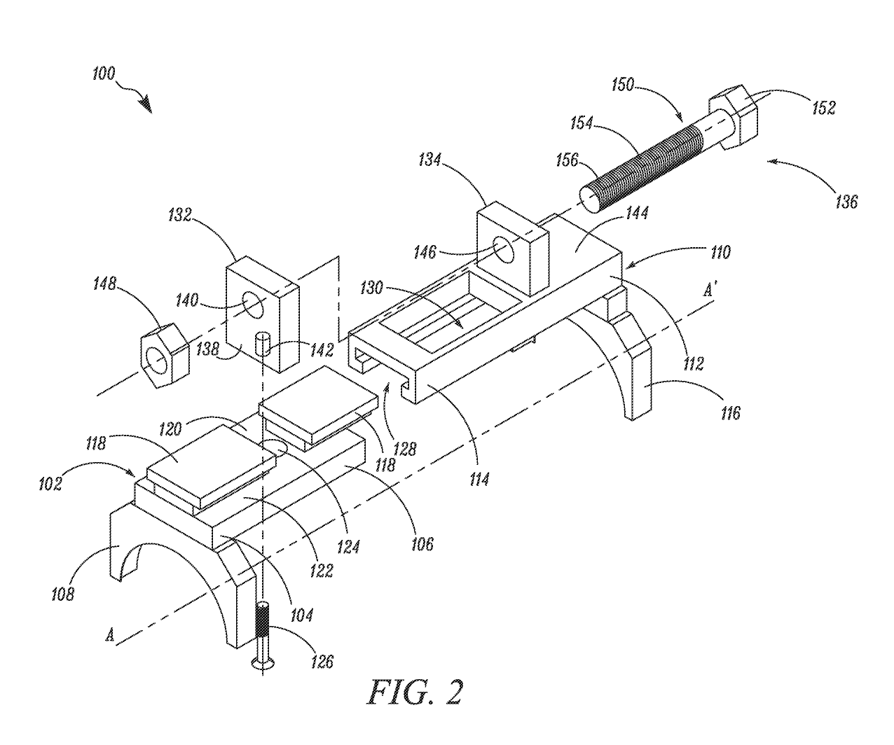

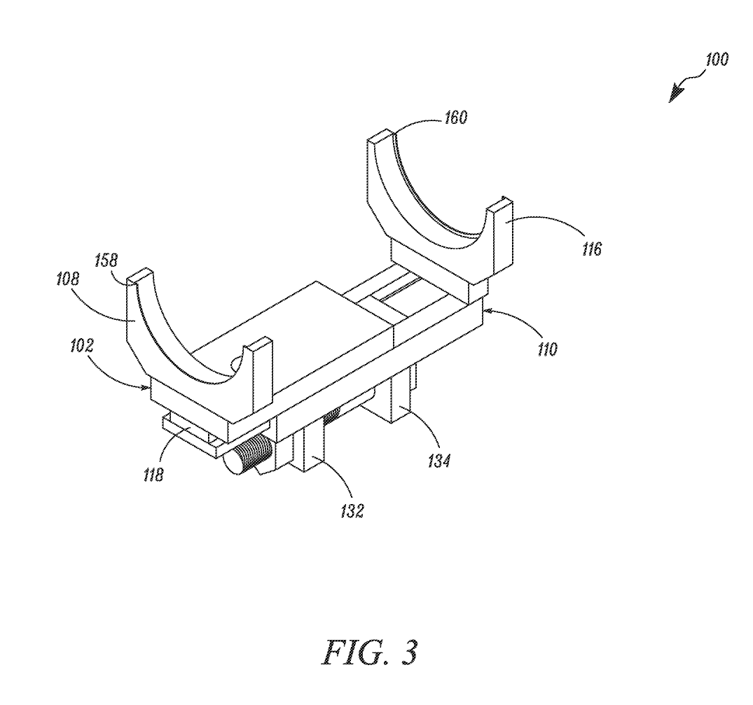

Referring now to FIGS. 2 and 3, which illustrate an exploded view and another isometric view of the manipulation tool 100, respectively. The first arm 102 includes an elongated protruding portion 118 having a gap 120. The elongated protruding portion 118 may be disposed along the longitudinal axis A-A′, on a top face 122 of the first arm 102. Alternatively, the elongated protruding portion 118 may be disposed along any other face of the first arm 102. In one exemplary embodiment, the elongated protruding portion 118 may extend longitudinally beyond the second end portion 106 of the first arm 102. The gap 120 is defined on the elongated protruding portion 118 such that a through-hole 124 may be provided in the gap 120. The through-hole 124 may be configured to receive a screw 126. Alternatively, the through-hole 124 may be configured to receive any other fastening member, such as a bolt.

The second arm 110 includes an elongated groove 128 having a slot 130. The elongated groove 128 may extend along the longitudinal axis A-A′. The elongated groove 128 may have a shape complimentary to a shape of the elongated protruding portion 118. Such complimentary shape of the elongated groove 128 enables the elongated protruding portion 118 of the first arm 102 to be slidably received within the elongated groove 128 of the second arm 110. The slidable positioning of the second arm 110 with respect to the first arm 102 in this exemplary embodiment enables movement of the first arm 102 with respect of the second arm 110.

The manipulation tool 100 further includes a first tab 132, a second tab 134 and a fastening mechanism 136. The first tab 132 may be coupled to the first arm 102 via various mechanisms. The first tab 132 may be disposed substantially perpendicular to the longitudinal axis A-A′. In an embodiment of the present disclosure, the first tab 132 has a rectangular configuration, having an end portion 138 at a side thereof in proximity to the second end portion 106. A first through-hole 140 is provided in the first tab 132 along the longitudinal axis A-A′. The first tab 132 further includes a threaded hole 142 in the end portion 138. The first tab 132 is configured to be at least partially received within the gap 120 of the first arm 102. More particularly, the end portion 138 of the first tab 132 is positioned in the gap 120 such that the threaded hole 142 comes in alignment with the through-hole 124 on the first arm 102. The screw 126 may be threadably engaged with the through-hole 124 on the first arm 102 and the threaded hole 142 on the first tab 132 to couple the first tab 132 to the first arm 102. While the present exemplary embodiment has been described with respect to a threaded fastener assembly 124, 126 and 142, various alternative methods of joining the first tab 132 to the first arm 102 are also possible, such as welding, brazing, rivets, bolts, adhesives or the like.

The second tab 134 is coupled to the second arm 110, such that the second tab 134 may extend upwardly from a top face 144 of the second arm 110. The second tab 134 may be also disposed substantially perpendicular to the longitudinal axis A-A′. In other embodiments of the present disclosure, the second tab 134 may be engaged with the second arm 110 using any conventional joining means, such as welding, brazing, rivets, bolts, or the like. Alternatively, the second tab 134 may be integral with the second arm 110 such that the second tab 134 and the second arm 110 are a single, unitary, and indivisible component. A second through-hole 146 may be provided on the second tab 134. The second through-hole 146 may have similar size as that of the first through-hole 140.

The fastening mechanism 136 may be configured to be engaged with the first tab 132 and the second tab 134. The fastening mechanism 136 includes a nut 148 and a bolt 150. The nut 148 may include an internal threaded surface. The bolt 150 may include a hexagonal head portion 152 and a threaded shaft 154 extending from the hexagonal head portion 152. The bolt 150 is configured to be inserted through each of the first through-hole 140 and the second through-hole 146. An end portion 156 of the threaded shaft 154 engages with the internally threaded surface of the nut 148. Tightening of the bolt 150 moves the first arm 102 with respect to the second arm 110.

In an alternative embodiment, the first arm 102 may include the elongated groove 128 having the slot 130, and the second arm 110 may include the elongated protruding portion 118 having the gap 120.

FIG. 3 illustrates another isometric view of the manipulation tool 100. A first lip portion 158 may be provided on the first engaging member 108. The first lip portion 158 is configured to be disposed at least partially around the outer axial surface 22 of the first flange portion 12. Further, a second lip portion 160 may be provided on the second engaging member 116. The second lip portion 160 is configured to be disposed at least partially around the outer axial surface 24 of the second flange portion 14. The first lip portion 158 and the second lip portion 160 may apply compressive forces on the outer axial surfaces 22 and 24, respectively, caused by a relative motion of the first arm 102 with respect to the second arm 110. The compressive forces may act inwardly along a plane substantially perpendicular to the longitudinal axis A-A′. Moreover, the compressive forces may increase frictional forces between the outer axial surfaces 22 and 24, and the respective first and the second lip portions 158 and 160 to restrict a non-axial movement of the bellows 10.

### INDUSTRIAL APPLICABILITY

The bellows 10 is configured to be expandable and contractible along the longitudinal axis A-A′. During the installation of the bellows 10 in the exhaust system 11, the bellows 10 is aligned with the first and the second exhaust pipes 18 and 20. When not under compression, the bellows 10 may be in an expanded state and have a length greater than or equal to a space between the first and the second exhaust pipes 18 and 20. To install the bellows 10 in the exhaust system 11, the bellows is typically compressed along the longitudinal axis A-A′.

The manipulation tool 100 of the present disclosure includes the first and the second engaging members 108 and 116 which may engage with the outer axial surfaces 22 and 24 of the first and the second flange portions 12 and 14, respectively. The fastening mechanism 136 may be operated to move the first engaging member 108 with respect to the second engaging member 116 along a longitudinal axis A-A′. The relative movement of the first and the second engaging members 108 and 116 may apply compressive forces on the outer axial surfaces 22 and 24, respectively. The compressive forces may not directly act on the convolutes of the convoluted body portion 16. Instead, the compression forces are transmitted to the convolutes from the first and the second engaging members 108 and 116 via the first and the second flange portions 12 and 14.

Generally, the convoluted body portion 16 of the bellows 10 has a thickness that is as small as possible depending on the design and application requirements of the bellows 10. That is, the bellows 10 is configured to contract and expand during operation. However, the first and the second flange portions 12 and 14 have a substantially increased thickness with regard to the convoluted body portion 16 to form a rigid connection with the first and the second exhaust pipes 18 and 20. Moreover, as the compressive forces of the manipulation tool 100 are not directly acting on the convoluted body portion 16, the likelihood of damage of the bellows 10 during manipulation thereof is significantly reduced.

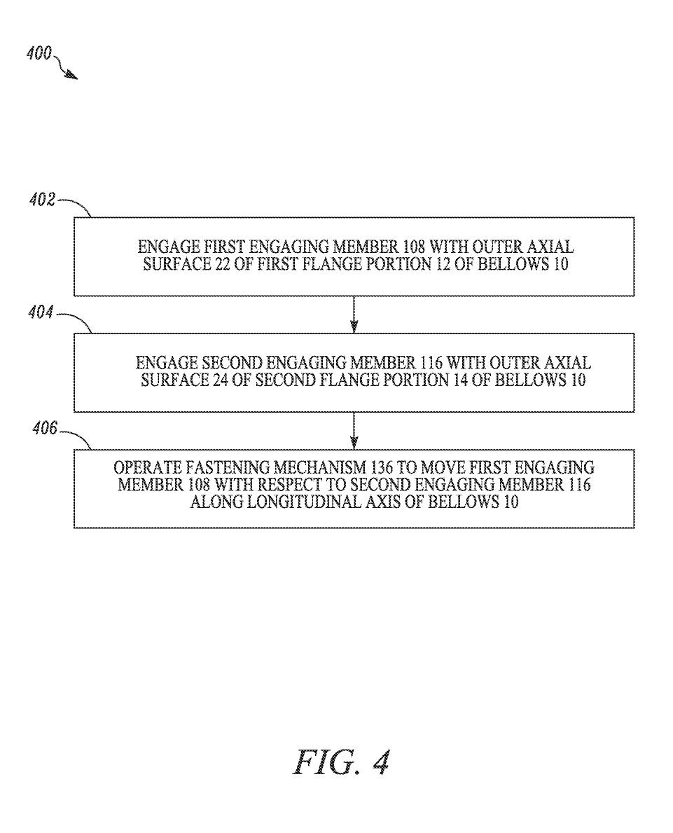

As depicted by a flow diagram in FIG. 4, a method 400 of manipulating the bellows 10, is disclosed herein. At step 402, the first engaging member 108 is removably engaged with the outer axial surface 22 of the first flange portion 12. At step 404, the second engaging member 116 is removably engaged with the outer axial surface 24 of the second flange portions 14. As described above, at steps 402 and 404, the first and the second lip portions 158 and 160, of the first and the second engaging members, may dispose around the outer axial surfaces 22 and 24, respectively.

At step 406, the fastening mechanism 136 is operated to move the first engaging member 108 with respect to the second engaging member 116. Thus, the first lip portion 158 and the second lip portion 160 may apply compressive forces on the outer axial surfaces 22 and 24, respectively. The compressive forces may be transferred to the convoluted body portion 16 of the bellows 10 via the first and the second flange portions 12 and 14. Under the action of the transferred compressive forces, the convolutes of the convoluted body portion 16 may be compressed to reduce the length of the bellows 10. Once the fastening mechanism 136 is loosened, the compression forces on the bellows 10 as applied by the manipulation tool 100 are released and the bellows 10 expands, thus tightly installing the bellows 10 in the exhaust system 11.

Moreover, according to illustrated embodiment in FIGS. 1-3, a linear extension of the manipulation tool 100, along the longitudinal axis A-A′, can be restricted to an axial length of the bellows 10 plus an axial width of the first and the second lip portion 158 and 160. In an embodiment, the linear extension of the manipulation tool 100 may be in a range of about 80 mm to 120 mm. Further, an overall height of the manipulation tool 100, orthogonal to the longitudinal axis A-A′, can be restricted to a height of the first and the second arms 102 and 110 plus a height of the first and the second tab 132 and 134. In an embodiment, the overall height of the manipulation tool 100 may be in a range of about 110 mm to 120 mm.

Further, according to illustrated embodiment in FIGS. 1-3, the first arm 102 and the second arm 110 may slidably move with respect to each other by operating the fastening mechanism 136. Further, a rotation of the nut 148 about the bolt 150, of the fastening mechanism 136, may enables the user to achieve a controlled linear compression on the bellows 10 based on a pitch of the threaded shaft 154. In various other embodiments, the fastening mechanism 136 may include a hydraulic, pneumatic, electric or other practical means to allow a movement of the first arm 102 relative to the second arm 110.

Moreover, the manipulation tool 100 may be manufactured of cast iron, steel or any other suitable material. Thus, the manipulation tool 100 according to an aspect of this disclosure is cost effective and easy to manufacture.

Aspects of this disclosure may also be applied to other flexible tube elements such as the bellows 10. Although, the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of this disclosure. It is intended that the specification and examples be considered as exemplary only, with a true scope being indicated by the following claims and their equivalents.

What is claimed is:

1. A manipulation tool for a bellows, the manipulation tool comprising:
a first arm;
a first engaging member extending from the first arm, the first engaging member configured to be removably engaged with an outer axial surface of a first flange portion of the bellows;
a second arm movably positioned with respect to the first arm along a longitudinal axis of the bellows; and
a second engaging member extending from the second arm, the second engaging member being configured to be removably engaged with an outer axial surface of a second flange portion of the bellows.

2. The manipulation tool of claim 1, wherein the first arm includes an elongated protruding portion disposed along the longitudinal axis.

3. The manipulation tool of claim 2, wherein the second arm includes an elongated groove disposed along the longitudinal axis, the elongated groove configured to slidably receive the elongated protruding portion of the first arm.

4. The manipulation tool of claim 3, further including
a first tab coupled to the first arm, wherein the first tab is disposed substantially perpendicular to the longitudinal axis;
a second tab coupled to the second arm, wherein the second tab is disposed substantially perpendicular to the longitudinal axis; and
a fastening mechanism configured to be engaged with the first tab and the second tab.

5. The manipulation tool of claim 4, wherein the fastening mechanism is configured to move the first arm with respect to the second arm.

6. The manipulation tool of claim 4, wherein the first tab includes a first through-hole and the second tab includes a second through-hole.

7. The manipulation tool of claim 6, wherein the fastening mechanism includes a nut and a bolt engageable with the nut, wherein the bolt is configured to be inserted through each of the first through-hole and the second through-hole.

8. The manipulation tool of claim 4, wherein the elongated protruding portion of the first arm includes a gap configured to at least partially receive the first tab.

9. The manipulation tool of claim 8, wherein a through-hole is provided on the gap.

10. The manipulation tool of claim 8, further including a screw configured to be received through the through-hole to couple the first tab to the first arm.

11. The manipulation tool of claim 8, wherein the elongated groove of the second arm includes a slot configured to be partially aligned with the gap of the elongated protruding portion.

12. The manipulation tool of claim 1, wherein the first engaging member include a first lip portion.

13. The manipulation tool of claim 12, wherein the first lip portion of the first engaging member is configured to be disposed at least partially around the outer axial surface of the first flange portion.

14. The manipulation tool of claim 1, wherein the second engaging member include a second lip portion.

15. The manipulation tool of claim 14, wherein the second lip portion of the second engaging member is configured to be disposed at least partially around the outer axial surface of the second flange portion.

16. A manipulation tool for a bellows, the manipulation tool comprising:
a first engaging member configured to be removably engaged with an outer axial surface of a first flange portion of the bellows;
a second engaging member configured to be removably engaged with an outer axial surface of a second flange portion of the bellows; and
a fastening mechanism configured to be operated to move the first engaging member with respect to the second engaging member along a longitudinal axis of the bellows.

17. The manipulation tool of claim 16 further including a first arm and a second arm movably positioned with respect to the first arm along the longitudinal axis, wherein the first engaging member extends from the first arm and the second engaging member extends from the second arm.

18. The manipulation tool of claim 16, wherein the first arm includes an elongated protruding portion and the second arm includes an elongated groove configured to slidably receive the elongated protruding portion of the first arm.

19. A method of manipulating a bellows, the method comprising;
engaging a first engaging member with an outer axial surface of a first flange portion of the bellows;
engaging a second engaging member with an outer axial surface of a second flange portion of the bellows; and
operating a fastening mechanism to move the first engaging member with respect to the second engaging member along a longitudinal axis of the bellows.

20. The method of claim 19, wherein operating the fastening mechanism includes moving a first arm connected to the first engaging member with respect to a second arm connected to the second engaging member.
